(19) United States
(12) Patent Application Publication
(10) Pub. No.: US 2003/0105797 A1
(43) Pub. Date: Jun. 5, 2003

(54) Dynamic load balancing among a set of servers

(76) Inventors: Dan Dolev, Mevaseret-Tzion (IL); Yizhak Silbinger, Herzelia (IL); Ronnen Edry, Hod-Husharon (IL)

Correspondence Address: Rashida A. Karmali, Esq., 99 Wall Street, New York, NY, 10005, US

(21) Appl. No.: 09/683,224

(22) Filed: Dec. 4, 2001

(51) Int. Cl. G06F 9/00

(52) U.S. Cl. 709/105

(57) ABSTRACT

The invention relates to a process and system for spreading requests for a service among a set of servers, where each one has a specified load allowed within each time frame. The invention provides a simple and fast solution to the dynamic assignment incoming requests among the servers, without violating their load limitation within a given time frame, and with keeping a fair allocation among them. It is an object of the invention to provide a scalable solution to assigning loads with minimal overhead.

### FIELD OF INVENTION

The present invention relates to a process and system for spreading requests among server computers connectable to a network for providing a service to one or more client computers also connected to the network. Specifically, it comprises of a traffic coordinator, data structures or vectors, to promptly process incoming requests and spread them without delay to a plurality of servers. The present invention optimizes the allocation of the requests using an objective token-based vector system, which dynamically balances the load on the servers without overloading them.

### BACKGROUND OF INVENTION

There is an increasing demand for high-powered server computers for networks and in particular, for the Internet. In the Internet, preventing a server from becoming overloaded with requests from clients may be accomplished by providing several servers having redundant capabilities or server farms in different geographical locations, and managing the distribution of client requests among servers through “load balancing.”

Load balancing involves spreading the load (of the requests from the users) among the various servers that may be in use so that no individual server is overwhelmed with client requests and becomes “toasted.” In this condition, the processor is overwhelmed by client requests and comes to a virtual halt, which may lead to excessive delays in providing service or cause the overloaded server to breakdown. The loss of a server can cause problems for the service provider. (Roy Zisapel et al., U.S. Pat. No. 6,249,801 B1, Jun. 19, 2001; Stanford-Clark, A. J. et al., EP 0 880 739 B1, Aug. 14, 1997.)

It is hence an object of the present invention to provide a mechanism to alleviate unbalanced load across the processors, thereby helping to avert the server breakdown.

One of the main challenges to be faced is the need for rapid and prompt processing of each request while at the same time ensuring that a server doesn't exceed its load limit. Another challenge is to handle a large number of flows concurrently by a process known as “scalable.” It is therefore another object of the present invention to provide a scalable solution to assigning loads with minimal overhead.

Stanford-Clark et al. talk about load balancing across the processors of the servers but the present invention goes beyond optimizing load balancing by allowing the service provider to allocate priorities in the use of the servers. The service provider may base the priorities on factors other than just the individual server's capacity.

The patent of Zisapel et al. does not provide a method for expanding the number of servers if the total load of the requests exceeds that of the servers' capacity. The present invention allows additional reserve sets of servers to be added on if there is a need for one.

There is thus a widely recognized need for a simple, fast system for the dynamic assignment of incoming requests among the servers that provides an objective and fair allocation of the requests among the servers without violating their load limitation within a given time frame.

### SUMMARY OF INVENTION

The present invention seeks to provide novel methods and systems for load balancing requests among network servers which overcome the known disadvantages of the prior art as discussed above.

Accordingly, the present invention provides a server coordinator connectable to a network and having a plurality of processors arranged to provide service to one or more client computers connected to the network, the service comprising the provision of data structures or vectors to each server, the server coordinator computer comprising two or more data structures to dynamically change the allocation of requests within the stream and to rapidly decide on the target of each request.

The method involves selecting a server and checking if the server has remaining capacity to handle the load associated with a certain request, before directing the request to the selected server. For example, the checking step may be optimized using a counter vector and the selecting step may be optimized using a token vector.

According to the present invention, there is provided a method for directing client requests involving an unexpected high load to one server out of a plurality of servers, by determining whether the server has capacity remaining to handle the expected load and therefore directing the requests to the server only if the server is capable of providing the service.

The invention includes allocation of one or more tokens to each of the plurality of servers so that during the selection of a server, the coordinator selects at least one token associated with each server.

According to further features in preferred embodiments of the invention, a system is provided wherein the probability of selecting a token associated with a server may differ from a probability of selecting a second token associated with at least one other of the servers.

According to still further features in the preferred embodiments, the number of tokens associated with a server is proportional to the load limitation of that server.

According to another embodiment of the invention, the probability of selecting a token from a specific server may be skewed, dependent on the remaining capacity of a server, in the same set of servers or in the reserve set of servers.

Yet another embodiment of the invention includes a number of tokens associated with a server, said number being disproportionate to the load limitation of that server.

The present invention includes a system comprising of a plurality of servers, a first memory divided into entries with at least one entry associated with each server and including an indication of the server, a second memory divided into entries with at least one entry associated with each server and including a representation of the remaining capacity of the server, and a selector for selecting from among the entries of the first memory.

The system further includes a system having at least one other set of servers to which requests may be allocated if there is no remaining capacity in any of the other servers.

The present invention also includes a program storage device readable by machine, comprising of a program of instructions executable by the machine to perform steps for directing a request involving an expected load to a server.

The present invention further comprises a computer program product comprising a computer useable medium having a computer readable program code embodied therein for directing a request involving an expected load to a server. The computer program product also comprises a computer readable program code for assisting the computer to select a server, or for selecting a server having remaining capacity to handle a load.

### BRIEF DESCRIPTION OF DRAWINGS

The invention will be understood from the following detailed description, by way of example only, taken in reference with the accompanying drawings, in which:

FIG. 1 is a description of the basic layout, according to one embodiment of the present invention;

FIG. 2 is a description of the data structures, according to one embodiment of the present invention;

FIG. 3 is a description of the method to direct a request, according to one embodiment of the present invention.

### DETAILED DESCRIPTION

The present invention is of an efficient method and system that spreads requests among servers preferably using two extra data structures (or vectors). Specifically, the present invention can be used to dynamically change the allocation and within the stream to immediately decide on the target of each request.

The data structures, system, and method, explained in more detail below, can be implemented by computer and/or non-computer means. Computer means can include software, hardware, firmware, etc., or any combination thereof.

Each of the servers, say server Si, has a load limitation Li. The value of Li is determined for example, either by a separate process or by an agreement among the service providers. Li is set to represent the total volume of requests that can be sent to the site within each time frame. One can limit Li to only the number of requests. Alternatively, one can, someone else can let it represent the estimate of the sum of loads of all the requests being sent to a site.

We preferably construct a vector, say T, of tokens that is proportional to the sum of all the load limitations of all the servers. The number of tokens associated with server Si is proportional to Li. The tokens of all servers in the vector may be are spread in the vector T, so no server will get too many requests back to back.

In one embodiment, tokens are randomly distributed in the vector. Starting from the beginning of the vector, in each time frame, tokens are chosen in descending order. Alternatively, one can give priority to servers by having their tokens appear more frequently in the first part of the vector, this way, within each time frame, we will begin sending requests to that server.

In other embodiments where tokens are randomly distributed in the vector, tokens can be selected in ascending order, starting from the bottom of the vector, in each time frame. In this case servers whose tokens appear more frequently in the bottom part of the vector achieve priority.

In other embodiments where tokens are randomly distributed in the vector, tokens can be selected beginning in the middle of the vector and in either ascending or descending order.

In certain embodiments where tokens are randomly distributed in the vector, starting again at the same place in the vector each time frame is unnecessary.

In another embodiment, tokens from each server are concentrated in different areas of the vector rather than randomly distributed. Tokens in this embodiment are chosen in random order, with the constraint that a particular token is not re-chosen until a time interval has passed from the last selection of that particular token. Alternatively, one can give priority to servers by having their tokens chosen more frequently than would be the case in random selection.

In certain embodiments of the invention, feedback on the actual load of the server is used when selecting the tokens. For example, if feedback indicates that server Si is close to load limitation Li (for example by examining entry Ci of vector C), then tokens associated with server Si may be are picked less frequently than would be the case in random selection.

In certain embodiments of the invention, servers are prioritized based on one or more factors. For example, prioritization can be based on the strength of the server (the amount of requests it can serve concurrently), the proximity of the server, and/or the bandwidth of the server, its service contract, its recent load, and more.

In certain embodiments of the invention, the number of tokens associated with server Si may not be fully proportional to Li. The number of tokens associated with server Si, is instead proportional to the priority in directing requests to server Si. The priority can be a function of a server's load limit and other factors the designer wish to represent. The larger the number of appearances of references (i.e. tokens) to a given server, the larger the chance of directing requests to it. One can implement the vector as a random choice with weights that represent the different priorities.

The distribution of tokens represent also the fairness among the servers, such that we do not load servers more than their relative order in the vector. By fairness we mean that if the total load at a certain time is not high, it is spread among the servers in a way that each one is loaded in proportion to its total allowed load. The same can be said regarding the load a server gets during each time frame; we will not want to assign to it its full load at once. If possible we wish to spread the load evenly during the time frame.

Preferably, In addition we also set up a vector, say C, of counters, where entrance Ci is associated with server Si. In one embodiment, each entry Ci is initially set to be equal to Li. Upon each request, the coordinator looks at the next token in the vector T. If the token is associated with a server say s, the coordinator reduces Cs by the amount of work, r, required by the request, and directs the request to server Ss. If and when Cs is reduced to zero, Ss is preferably taken out of the game and tokens associated with Ss can no longer be chosen (during the same time frame). Alternatively, if Ss is taken out of the game, tokens associated with Ss may continue to be chosen, but the direction of the request to server Ss will be stopped prior to execution. At the beginning of the next time frame, the out of the game server Ss will get a fresh assignment of tokens. Preferably once every time frame all entries in the vector C are set back to their original values, i.e. the allowed load limits, Ls, of the given server s. Note that the rate at which we reset the vector C is a parameter that can be tuned by the system designer. The higher the rate, the smaller the load limit should be, and the smaller the in-balance one can see in the loads.

In another embodiment, each entry Cs is initially set to be equal to 0. Cs is increased by the amount of work, r, required by the request. If and when Cs is increased to Ls, Ss is preferably taken out of the game and tokens associated with Sₛ can no longer be chosen (during the same time frame). Alternatively, if Ss is taken out of the game, tokens associated with Ss may continue to be chosen, but the direction of the request to server Ss will be stopped prior to execution. At the beginning of the next time frame, the out of the game server Ss will get a fresh assignment of tokens. Preferably once every time frame all entries in the vector C are set back to their original values (i.e. zero). As noted above, the rate at which we reset the vector C is a parameter that can be tuned by the system designer. The higher the rate, the smaller the load limit should be, and the smaller the in-balance one can see in the loads.

It should be evident to those in the art that other embodiments are possible which retain the features of changing entry Ci based on the amount of work, r, required by requests and evaluating whether server Si should be taken out the game.

It should also be evident that more than one entry Cs can be associated with a certain server Ss and that changes based on the amount of work r can affect one or more entries Cs and that evaluation of whether server Ss should be taken out of the game would be then based on all of the more than one entries Cs

The workload r is an application parameter that represents the request type. Using as an example the Internet, the workload can be as simple as a constant number per request or a function of the page fetched and the page's characteristics. Alternatively, the workload can be a function of the above and in addition a function of the type of request, for example if the request is only for the text in the web page it should be considered as a lower load than asking for the full page, if it is full with pictures.

In our model, the coordinator is given a list of servers, grouped into sets. The top (primary) set of servers should take upon them to serve the requests, unless the total amount of requests per time frame exceeds the sum of all the load limitations of all the servers in that set. In that case, the coordinator may assign requests to servers in the second set (a reserve set) and so on to other, if available, reserve sets if necessary. There may be more than one coordinator, and a server may appear in more than one set. The assignment of servers to the primary set and/or to reserve sets can be based on one or more factors. For example, certain servers belonging to a reserve set for current service of certain applications, web sites, functions, etc. may belong to a primary set for other applications, web sites, function, etc. As another example, slower, weaker, and/or servers that are farther away may be assigned to a reserve set. Preferably, the servers in the reserve set will be used for the current service only if there is no other choice.

The principles and operation of the system and method for dynamic load balancing among a set of servers according to the present invention may be better understood with reference to the description and the accompanying drawings in which:

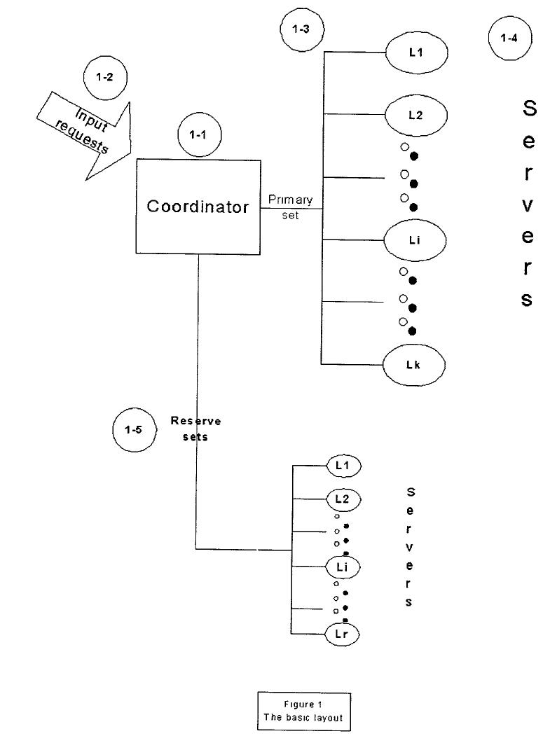

FIG. 1 illustrates an example of the basic layout of the invention.

(1-1) The coordinator performs the protocol described in this invention to decide to which server to direct a given request. The coordinator needs to complete its decision in the fastest possible way, while maintaining fairness among servers, and not assigning too many requests to any server.

(1-2) There is a stream of requests that need to be served. Each request has a load it will incur on the server, described by a number r. It needs to be directed to one or more of the a specific servers.

(1-3) There is a primary set of servers that are responsible to server the requests.

(1-4) Each of the servers has a load limitation of Li requests, which is the maximum number of request load it can incur within a time frame.

(1-5) One can have one or more extra (reserve) sets of servers that can be used if the total load of the requests exceeds the limit set by the total sum of the load limit of all the servers in the primary set. These are is an optional sets, if there is no such set, or if all such sets are saturated, the request will be declined.

Preferably, each set has its own token and counter vectors. In other embodiments, one or more sets can be represented in the same token and/or counter vectors.

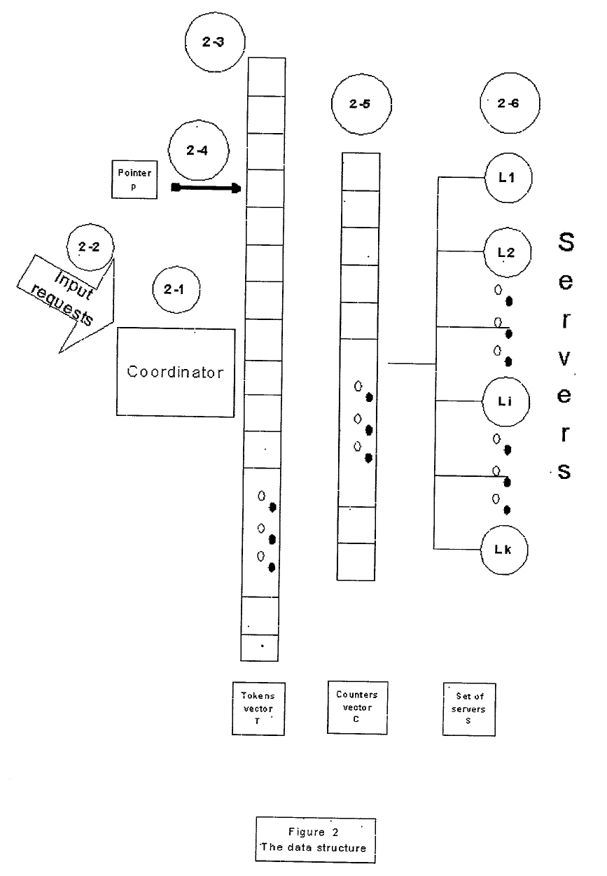

FIG. 2 illustrates an example of the basic data structures used for the primary set of servers. In order not to crowd the figure, the reserve set(s) and/or their data structures are not shown here.

(2-1) The coordinator maintains an internal set of variables. The variables provide indications to the coordinator. For example, the variables can indicate when a new timeframe begins, who the members of each set are, how to read the results, how to communicate back with each request, and other implementation issues. The usage of internal variables for the coordinator is well known in the art and will therefore not be further elaborated on.

(2-2) All the incoming requests are maintained in waiting queue until they are directed by the coordinator to the right server. Our goal is that the queue will preferably be small at all times.

(2-3) Preferably, there is a tokens' vector which represents a set of random choices of which server to choose at each instance. Each token contains an indication (for example an address) of one of the servers. Refer to the detailed explanation of the tokens' vector presented above Once the load limit of a server changes one can change the percentage of its tokens in the vector T.

(2-4) The pointer points at the current choice of a server to direct a request to. As detailed above, in the simplest to implement form of our invention all the elements (tokens) in the vector T are randomly distributed, and the pointer goes along the vector cell by cell either up or down (and moves to the top/bottom once it reaches the bottom/top, and/or preferably at the beginning of each time slot). In another embodiment, the pointer can move randomly among the cells, in which case the vector's entries (tokens) need not be randomized. It should be evident that other pointer movement paths are within the scope of the invention.

(2-5) Preferably there is a counters' vector which represents the remaining capacity for a given time frame for each server, as explained above. As explained above, one or more entries in the vector can be held per server.

(2-6) The primary set of servers is shown.

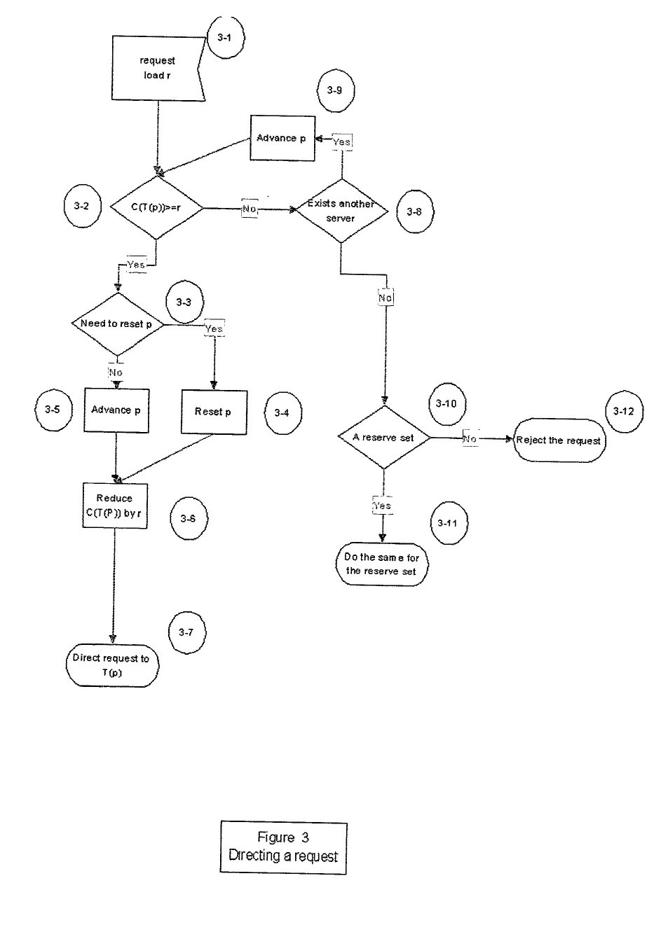

FIG. 3 illustrates one embodiment of a method of directing a request to a server. The method assumes that the tokens are selected in descending order and that the initial entries of C are set to the load limitation of the corresponding servers. It should be evident that the method can be easily adjusted for other types of token selection and initial entries of C.

(3-1) Each request carries its expected load, say r. The expected load r is a function of the request type, as explained above

(3-2) We use the data structures of FIG. 2 to determine the right server. We use the pointer (2-4) and the vector T to pick up the identity of the next candidate server, T (p). We check whether server T (p) can carry the load r, by comparing its counter C (T (p)) with r.

(3-3) We check whether the pointer p points to the end of vector T, or whether there is a need to reset it. One may choose to reset p every time frame.

(3-4) If it points to the end we reset p to the top of T.

(3-5) Otherwise advance p to the next cell in T.

(3-6) Reduce the remaining load capacity C (T (p)) of server T (p) by r.

(3-7) Direct the request to server T (p).

(3-8) Since server T (p) can't carry out the request we need to look for another server. It might be that all the servers at this time frame already used their allocation, in which case we switch to (3-10). If any server is left in the current set we switch to (3-9). We didn't say explicitly how one check this, but an internal variable or additional vector can be used to indicate which servers are out of capacity in the current time frame. If a server that has been taken out is selected, we remove the token and try again.

(3-9) Advance p to the next available server, which would be in most cases the next entry (token) in the vector T. If p is at the end of the vector, we reset it, as we did in (3-4). If advancing P to the next entry, instead selects a token of the same server, which cannot handle the request, one can keep on advancing until a token of another server is selected. Alternatively, selection of all tokens of the same server that cannot handle the request may be blocked. The blocking may require additional steps, such as merging the tokens and the load structure, and enriching the vector at each time slot. (3-10) Since the previous set is out of capacity we look to see whether the coordinator has another reserve set to switch to.

(3-11) If a reserve set exists, we carry the same process (3-2) to (3-9) for that set, until the beginning of the next time frame, in which case we can preferably switch back to the primary set. (3-12) In the case that we ran out of reserve sets, we reject the request. One may choose to delay the request until the time frame expires and to try again.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention. While the invention has been described with respect to a limited number of embodiments, it will be appreciated that many variations, modifications and other applications of the invention may be made.

1. A method for directing a request involving an expected load to one server out of a plurality of servers, comprising the steps of:
selecting a server;
determining whether said selected server has remaining capacity to handle said expected load; and
directing the request to said selected server, only if said server has remaining capacity to handle said expected load.

2. The method of claim 1, further comprising the step of:
providing at least one token associated with each of the plurality of servers; and
wherein said step of selecting a server includes the step of selecting at least one token associated with said server.

3. The method of claim 2, wherein a probability of selecting a token associated with said server differs from a probability of selecting a token associated with at least one other of the plurality of servers.

4 The method of claim 2, wherein said step of providing at least one token includes the step of:
providing a number of tokens associated with each of the plurality of servers, wherein said number is proportional to a the load limitation of each of said plurality of servers.

5 The method of claim 4, further comprising the step of skewing the a probability of selection of a at least one token associated with said server, said skewed probability being disproportionate to said the number of tokens associated with said server.

6. The method of claim 2, wherein said step of providing at least one token includes the step of:
providing a number of tokens associated with each of the plurality of servers, wherein said number is disproportionate to a load limitation of each of said plurality of servers and said number is at least partly based on a priority of each of the plurality of servers.

7. The method of claim 1, further comprising the step of:
changing said remaining capacity to reflect said expected load if said request is directed to said server.

8. The method of claim 1, further comprising the step of:
selecting another server if said server does not have remaining capacity to handle said expected load.

9. The method of claim 8, wherein said other server is part of the same set.

10. The method of claim 8, wherein said other server is part of a reserve set.

11. The method of claim 1, further comprising the step of:
resetting said remaining capacity for each time frame.

12. A system for allocating requests among servers, comprising:
a plurality of servers;
a first memory divided into entries, with at least one entry associated with each server and including an indication of said server;
a second memory divided into entries, with at least one entry associated with each server and including a representation of a remaining capacity of said server; and
a selector for selecting from among said entries of said first memory.

13. The system of claim 12, further comprising:
at least one other set of at least one server to which requests can be allocated if there is no remaining capacity in any of said plurality of servers.

14. A program storage device readable by machine, tangibly embodying a program of instructions executable by the machine to perform method steps for directing a request involving an expected load to one server out of a plurality of servers, comprising the steps of:
selecting a server;
determining whether said selected server has remaining capacity to handle said expected load; and
directing the request to said selected server, only if said server has remaining capacity to handle said expected load.

15. A computer program product comprising a computer useable medium having computer readable program code embodied therein for directing a request involving an expected load to one server out of a plurality of servers, the computer program product comprising:
computer readable program code for causing the computer to select a server;
computer readable program code for causing the computer to determine whether said selected server has remaining capacity to handle said expected load; and
computer readable program code for causing the computer to direct the request to said selected server, only if said server has remaining capacity to handle said expected load.
